(19) United States
(12) Patent Application Publication
(10) Pub. No.: US 2026/0002584 A1
(43) Pub. Date: Jan. 1, 2026

(54) SPROCKET AND TRANSMISSION MECHANISM

(71) Applicant: TSUBAKIMOTO CHAIN CO., Osaka (JP)

(72) Inventors: Yudai Takagi, Osaka (JP); Shoichiro Shimizu, Osaka (JP); Akira Hirai, Osaka (JP)

(73) Assignee: TSUBAKIMOTO CHAIN CO., Osaka (JP)

(21) Appl. No.: 19/221,821

(22) Filed: May 29, 2025

(30) Foreign Application Priority Data
Jun. 28, 2024 (JP) 2024-104704

(51) Int. Cl. F16H 55/30; F16H 7/06

(52) U.S. Cl. CPC F16H 55/30; F16H 7/06

(57) ABSTRACT

Provided is a sprocket that mitigates the influence of tension fluctuation corresponding to load torque fluctuation, suppresses the occurrence of order noise corresponding to the cycle of the load torque fluctuation while suppressing noise and vibration, and prevents an increase in the tension fluctuation as well as an increase in the noise and vibration caused by resonance. A plurality of teeth meshing with a chain are arranged such that an adjacent angular phase θn of each of the plurality of the teeth is non-uniform. In a case where an angular phase obtained when all the teeth are arranged in a uniform angular phase is defined as θ (360°/the number of teeth), the adjacent angular phase θn of each of the teeth includes a site where θ+1.5°≥θn≥θ+0.1° and a site where θ−0.1°≥ θn≥θ−1.5°.

### BACKGROUND OF THE INVENTION

### 1. Field of the Invention

The present invention relates to a sprocket having a plurality of teeth formed thereon to mesh with a chain, and to a transmission mechanism.

### 2. Description of the Related Art

As a transmission mechanism that reliably transmits rotation, a transmission mechanism, in which a chain is wound around a sprocket having a plurality of teeth formed on the peripheral surface of a main body thereof, has been conventionally used.

The meshing of the teeth of the sprocket with the chain leads to the reliable transmission of timing and rotational force between a plurality of sprockets. However, the occurrence of noise and vibration due to the meshing is inevitable.

In the case of a transmission mechanism in which a load torque cyclically fluctuates with rotation, a publicly known sprocket (see, e.g., Japanese Patent Application Laid-open No. 2009-156320) has been used, which mitigates the influence of tension fluctuation corresponding to load torque fluctuation and suppresses noise and vibration. In this sprocket, a plurality of teeth are arranged to form a phase fluctuation pattern, in which the phase alternately fluctuates in both the positive and negative directions when the phase, at which each of the plurality of teeth meshes with the chain at even intervals is defined as zero, so as to mitigate the tension fluctuation in synchronization with the cyclic fluctuation of the load torque.

### SUMMARY OF THE INVENTION

In the publicly known sprocket, it is possible to suppress the noise caused by chain vibration by mitigating tension fluctuation. However, since the load torque fluctuation is cyclic, the occurrence of order noise corresponding to the cycle is inevitable.

Furthermore, when the phase of the load torque fluctuation is deviated, or when resonance occurs between the rotational speed of the sprocket and the inherent vibration frequency of the chain, there is a possibility that the tension fluctuation may increase instead, or that noise and vibration may increase.

The present invention aims to solve these problems and has an object of providing a sprocket that mitigates the influence of tension fluctuation corresponding to load torque fluctuation, suppresses the occurrence of order noise corresponding to the cycle of the load torque fluctuation while suppressing noise and vibration, and prevents an increase in the tension fluctuation as well as an increase in the noise and vibration caused by the phase deviation of the load torque fluctuation, resonance, or the like.

In order to solve the above problems, a sprocket according to the present invention has a plurality of teeth formed thereon to mesh with a chain, wherein the plurality of teeth are arranged such that an adjacent angular phase θn of each tooth of the plurality of teeth is non-uniform, and wherein in a case where an angular phase obtained when all the teeth are arranged in a uniform angular phase is defined as θ (360°/the number of teeth), the adjacent angular phase θn (where n ranges from 1 to the number of teeth) of each of the teeth includes a site where θ+1.5°≥θn≥θ+0.1° and a site where θ−0.1°≥θn≥θ−1.5°.

According to the sprocket of claim 1 and the transmission mechanism of claim 7, a plurality of teeth are arranged such that an adjacent angular phase θn of each of the plurality of teeth is non-uniform. In a case where an angular phase obtained when each tooth is arranged in a uniform angular phase is defined as θ (360°/the number of teeth), the adjacent angular phase θn (where n ranges from 1 to the number of teeth) of each of the teeth includes a site where θ+1.5°≥θn≥θ+0.1° and a site where θ−0.1°≥θn≥θ−1.5°. Thus, it is possible to set portions where the fluctuation cycle of the load torque deviates from the cycles of a plurality of phase fluctuations, thereby suppressing the occurrence of order noise corresponding to the fluctuation cycle of the load torque, as well as suppressing resonance. As a result, an increase in tension fluctuation as well as an increase in noise and vibration caused by phase deviation, resonance, or the like of the load torque fluctuation may be prevented.

When the adjacent angular phase θn of each of the teeth satisfies θ+0.1°>θn>θ−0.1°, the phase fluctuation of the tooth is small. Therefore, the influence of the load torque fluctuation may not be effectively eliminated.

Furthermore, when the adjacent angular phase θn of each tooth satisfies θn>θ+1.5° or θ−1.5°>θn, the influence of the load torque fluctuation may be eliminated. However, the influence of the occurrence of order noise caused by tension fluctuation due to the phase fluctuation of the teeth becomes significant, leading to an increase in noise and vibration.

According to the configuration of claim 2, the adjacent angular phase θn of each of the teeth is set to repeatedly increase and decrease in a cycle of three to nine times per rotation. Thus, it is possible to smoothly change the timing at which the phase deviation occurs between the fluctuation cycle of the load torque and the cycle of the phase fluctuation of the teeth and further suppress the occurrence of order noise.

When the increasing and decreasing cycle per rotation is less than three times, it becomes difficult to eliminate the influence of the load torque fluctuation.

When the increasing and decreasing cycle per rotation exceeds nine times, the influence of the occurrence of the order noise caused by the tension fluctuation due to the phase fluctuation of the teeth becomes significant, leading to an increase in noise and vibration.

According to the configuration of claim 3, a valley of an increasing and decreasing cycle of the adjacent angular phase θn of each of the teeth is arranged to correspond to a tooth where chain tension is maximized due to cyclically fluctuating load torque. Thus, it becomes possible to reduce the peak value of actual chain tension and further effectively mitigate the influence corresponding to the load torque fluctuation.

According to the configuration of claim 4, an increasing and decreasing cycle of the adjacent angular phase θn of each of the teeth differs from a fluctuation cycle of a maximum load torque generation source among a plurality of load torque generation sources. Thus, it becomes possible to further effectively mitigate the influence corresponding to the load torque fluctuation.

For example, when used in a transmission mechanism that transmits output from the crankshaft of an engine, a plurality of load torque generation sources with different cycles exist, such as crankshaft load, camshaft load, oil pump load, and balancer shaft load. By making the fluctuation cycle of the crankshaft load, which is the source of the maximum load torque, different from the fluctuation cycle of the torque that predominantly governs tension generation among such torques, or from the fluctuation cycle of the combined torque load, it becomes possible to effectively mitigate the influence corresponding to the load torque fluctuation.

According to the configuration of claim 5, the plurality of teeth are made of a sintered material. Thus, the appropriate roughness and porosity of the sintered surface provide impregnated-oil retention properties, and the porosity attenuates air vibration during the contact between the chain and the sprocket, leading to a noise reduction effect.

Furthermore, it becomes also possible to deviate the resonance point during meshing by controlling the mass on the basis of the sintered density.

According to the configuration of claim 6, the plurality of teeth include a tooth having an actual pitch circle diameter larger or smaller than a pitch circle diameter of a standard tooth profile. Thus, the kinetic energy in the vertical direction of the chain due to its polygonal motion is reduced, enabling a further reduction in overall noise and vibration.

According to the configuration of claim 8, the plurality of sprockets include a sprocket in which arrangement of an adjacent angular phase θn of each tooth over an entire circumference is reversed. Thus, without increasing the increasing and decreasing cycle per rotation of the adjacent angular phase θn of each tooth in a single sprocket, it is possible to finely set portions where the fluctuation cycle of the load torque deviates from the cycles of a plurality of phase fluctuations in the overall transmission mechanism, thereby further suppressing the occurrence of order noise.

Furthermore, by aligning the phases of the valleys of the increasing and decreasing cycles of adjacent sprockets when the chain is wound around the sprockets, it becomes possible to obtain valleys that are even deeper.

According to the configuration of claim 9, the plurality of sprockets include a sprocket that is arranged to form a phase fluctuation pattern having a different wavelength portion, in which a phase fluctuates in both positive and negative directions when the phase, at which each tooth of the plurality of teeth meshes with a chain at even intervals, is defined as zero, so as to mitigate tension fluctuation in synchronization with cyclic fluctuation of load torque, the phase fluctuation pattern having a wavelength that is set to change continuously in a circumferential direction from a large level to a small level or from a small level to a large level. Thus, it becomes possible to mitigate the influence of tension fluctuation corresponding to load torque fluctuation and suppress noise and vibration.

### BRIEF DESCRIPTION OF THE DRAWINGS

FIG. 1 is an explanatory diagram showing an adjacent angular phase θn of each tooth of a sprocket according to an embodiment of the present invention;

FIG. 2 is an explanatory diagram showing the phase relationship between the adjacent angular phase θn of each tooth of the sprocket and load torque according to the embodiment of the present invention;

FIG. 3 is an explanatory diagram showing the phase relationship between the adjacent angular phase θn of each tooth of the sprocket adjusted in the direction of increasing tension and the load torque;

FIG. 4 is an explanatory diagram showing the relationship between the rotational speed and tension of the sprocket according to the embodiment of the present invention; and

FIG. 5 is an explanatory diagram showing the relationship between the rotational speed and noise of the sprocket according to the embodiment of the present invention.

### DESCRIPTION OF THE PREFERRED EMBODIMENTS

The sprocket of the present invention is a sprocket having a plurality of teeth formed thereon to mesh with a chain. The plurality of teeth are arranged such that an adjacent angular phase θn of each tooth is non-uniform. In a case where an angular phase obtained when all teeth are arranged in a uniform angular phase is defined as θ (360°/the number of teeth), the adjacent angular phase θn of each tooth includes a site where θ+1.5°≥θn≥θ+0.1° and a site where θ−0.1°≥θn≥θ−1.5°. The specific configuration of the sprocket may be arbitrary as long as it mitigates the influence of tension fluctuation corresponding to the load torque fluctuation, suppresses the occurrence of order noise corresponding to the cycle of the load torque fluctuation while suppressing noise and vibration, and prevents an increase in the tension fluctuation as well as an increase in the noise and vibration caused by the phase deviation, resonance, or the like of the load torque fluctuation.

The chain wound around the sprocket may be any type, such as a silent chain, a roller chain, or a bush chain, and may also be a flexible transmission member, such as a timing belt, as long as it has a structure that meshes with the teeth of the sprocket.

An example of the sprocket of the present invention, which has 20 teeth and is fixed to the crankshaft of an in-line four-cylinder four-cycle engine, will be described.

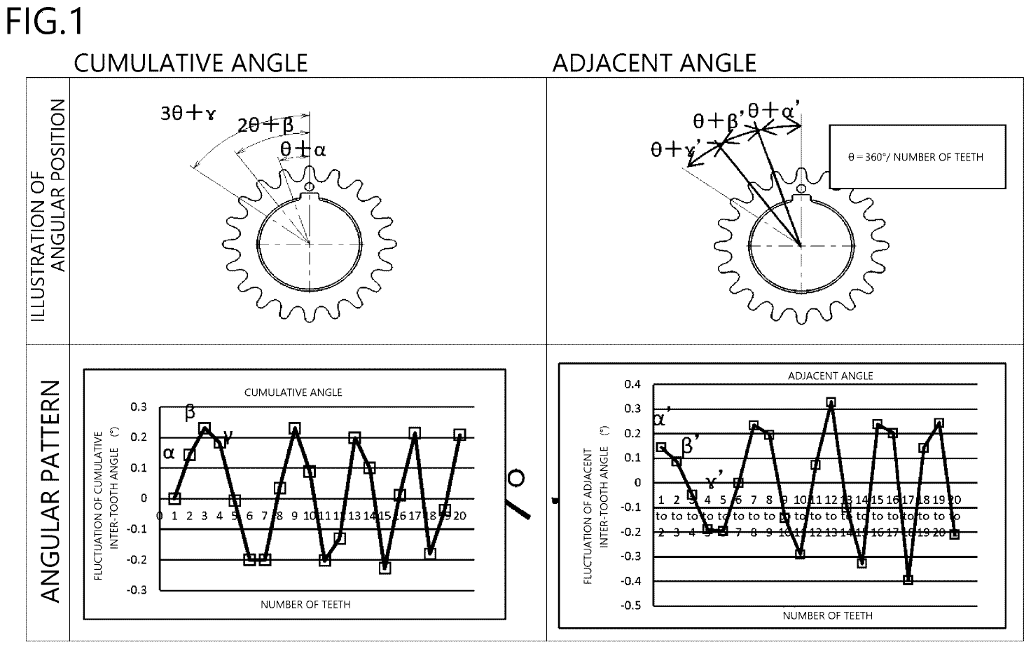

As shown in FIG. 1, in a case where the angular phase obtained when all teeth are arranged in a uniform angular phase is defined as θ (360°/the number of teeth), the adjacent angular phase θn of the sprocket is set to θ+α′, θ+β′, θ+γ′, . . . , in order from the topmost tooth in the figure in the counterclockwise direction (see the upper right figure of the table), and the lower right figure of the table shows a graphical representation of the adjacent angular phase θn for 20 teeth.

The cumulative angular phase of each tooth is sequentially in the order of θ+α, 2θ+β, 3θ+γ, . . . , where α=α′, β=α′+β′, γ=α′+β′+γ′ (see the upper left figure of the table), and the differences in the angular phase from a case where all the teeth are arranged in a uniform angular phase are α, β, γ, . . . , in order the topmost tooth in the figure in the counterclockwise direction.

The lower left figure of the table shows a graphical representation of the cumulative angular phase for 20 teeth.

In this embodiment, eight sites where θ+1.5°≥θn≥θ+0.1° and eight sites where θ−0.1°≥θn≥θ−1.5° are included.

Furthermore, the adjacent angular phase θn of each tooth is set to repeatedly increase and decrease in a cycle of five times per rotation.

The crankshaft of the in-line four-cylinder four-cycle engine has two cycles of torque fluctuations per rotation, and the camshafts (two in the case of DOHC) also have two cycles of torque fluctuations per rotation of the crankshaft.

The torque fluctuations that predominantly govern the tension depend on conditions, but there are at least two teeth where the chain tension is maximized due to cyclically fluctuating load torque.

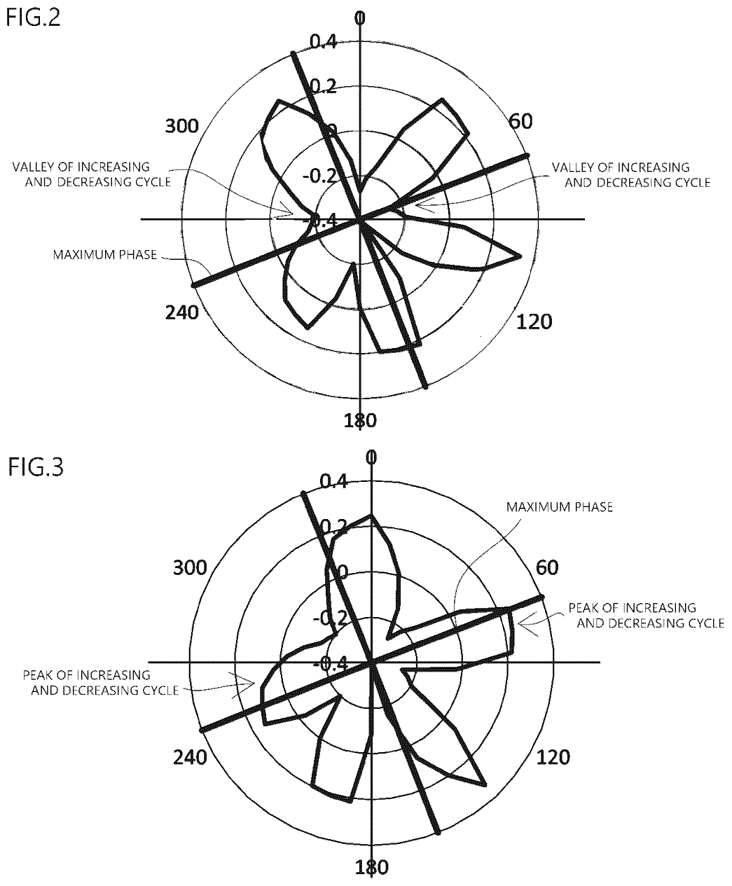

In this embodiment, as shown in FIG. 2, the valleys of the increasing and decreasing cycles of the adjacent angular phase θn of each tooth are arranged to correspond to the positions of the teeth at two sites where the chain tension is maximized due to the load torque. Tension fluctuation is dispersed, and its peak value is reduced.

On the other hand, as shown in FIG. 3, when the peaks of the increasing and decreasing cycles of the adjacent angular phase θn of each tooth are arranged to correspond to the positions of the teeth at the two sites where the chain tension is maximized due to the load torque, the chain tension further increases compared to a standard sprocket.

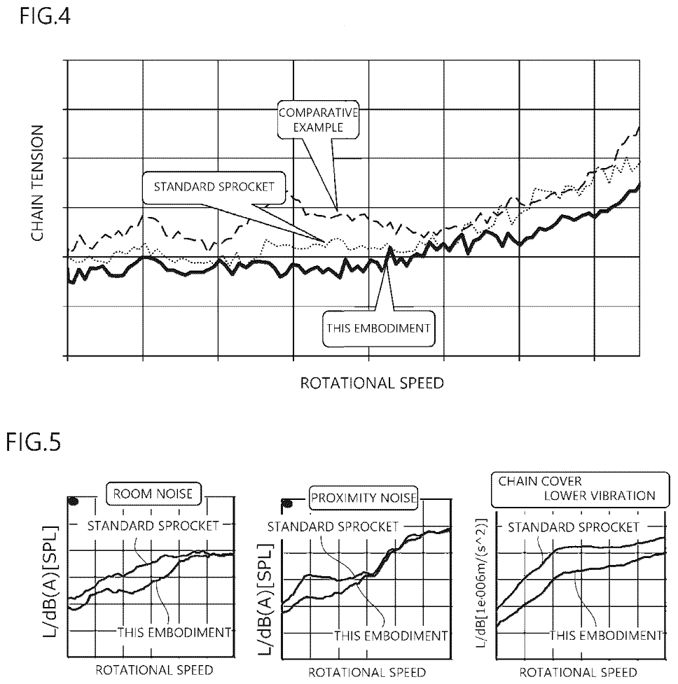

FIG. 4 shows the relationship between rotational speed and tension among the standard sprocket, the sprocket of this embodiment with the phase arrangement shown in FIG. 2, and the sprocket of a comparative example with the phase arrangement shown in FIG. 3, which increases and decreases in the adjacent angular phase θn similar to this embodiment.

As can be seen from the graph of FIG. 4, the sprocket of this embodiment shows lower tension than the standard sprocket in almost all rotational speed regions.

Thus, the influence of tension fluctuation corresponding to load torque fluctuation may also be mitigated, and noise and vibration may be suppressed.

FIG. 5 shows the results of noise measurement obtained when the sprocket of this embodiment is attached to a balancer shaft that is rotationally driven by a chain from the crankshaft of the in-line four-cylinder four-cycle engine.

Both proximity noise and chain cover lower part vibration sound show lower values than those obtained when the standard sprocket is used, and room noise is reduced by 2 dB or more in the normal rotational speed region of the engine.

In the sprocket of the present invention, a plurality of teeth may be configured to include those with an actual pitch circle diameter larger or smaller than the pitch circle diameter of a standard tooth profile.

This configuration changes the sprocket pitch relative to the chain pitch, and a change in the “play” of the chain alters the load distribution, leading to an increase in the strength of the sprocket and the inner and outer parts of the chain, as well as a reduction in vibration and noise.

Furthermore, the entire sprocket may be integrally made of a sintered material, or only a portion including a plurality of teeth may be made of a sintered material.

Although the embodiments described above are specific examples of the sprocket according to the present invention, the sprocket according to the present invention is not limited these examples and may be modified in various ways.

What is claimed is:

1. A sprocket having a plurality of teeth formed thereon to mesh with a chain, wherein
the plurality of teeth are arranged such that an adjacent angular phase θn of each tooth of the plurality of teeth is non-uniform, and wherein
in a case where an angular phase obtained when all the teeth are arranged in a uniform angular phase is defined as θ (360°/the number of teeth),
the adjacent angular phase θn (where n ranges from 1 to the number of teeth) of each of the teeth includes
a site where θ+1.5°≥θn≥θ+0.1°, and
a site where θ−0.1°≥θn≥θ−1.5°.

2. The sprocket according to claim 1, wherein
the adjacent angular phase θn of each of the teeth is set to repeatedly increase and decrease in a cycle of three to nine times per rotation.

3. The sprocket according to claim 2, wherein
a valley of an increasing and decreasing cycle of the adjacent angular phase θn of each of the teeth is arranged to correspond to a tooth where chain tension is maximized due to cyclically fluctuating load torque.

4. The sprocket according to claim 2, wherein
an increasing and decreasing cycle of the adjacent angular phase θn of each of the teeth differs from a fluctuation cycle of a maximum load torque generation source among a plurality of load torque generation sources.

5. The sprocket according to claim 1, wherein
the plurality of teeth are made of a sintered material.

6. The sprocket according to claim 1, wherein
the plurality of teeth include a tooth having an actual pitch circle diameter different from a pitch circle diameter of a standard tooth profile.

7. A transmission mechanism comprising: a plurality of sprockets; a shaft to which the plurality of sprockets are attached; and a chain wound around the plurality of sprockets, wherein
the plurality of sprockets include the sprocket according to claim 1.

8. The transmission mechanism according to claim 7, wherein
the plurality of sprockets include a sprocket in which arrangement of an adjacent angular phase θn of each tooth over an entire circumference is reversed.

9. The transmission mechanism according to claim 7, wherein the plurality of sprockets include a sprocket that is arranged to form a phase fluctuation pattern having a different wavelength portion, in which a phase fluctuates in both positive and negative directions when the phase, at which each tooth of the plurality of teeth meshes with a chain at even intervals, is defined as zero, so as to mitigate tension fluctuation in synchronization with cyclic fluctuation of load torque, the phase fluctuation pattern having a wavelength that is set to change continuously in a circumferential direction from a large level to a small level or from a small level to a large level.
